(19) United States
(12) Patent Application Publication
(10) Pub. No.: US 2024/0300126 A1
(43) Pub. Date: Sep. 12, 2024

(54) RAZOR BLADE

(71) Applicant: DORCO CO., LTD., Yongin-si (KR)

(72) Inventors: Min Joo PARK, Yongin-si (KR); Hyun Kyu JUNG, Yongin-si (KR); Seong Won JEONG, Yongin-si (KR); Myoung Jin KIM, Seoul (KR)

(21) Appl. No.: 18/667,239

(22) Filed: May 17, 2024

Related U.S. Application Data
(63) Continuation of application No. PCT/KR2022/018358, filed on Nov. 18, 2022.

(30) Foreign Application Priority Data
Nov. 19, 2021 (KR) 10-2021-0160597

(51) Int. Cl. B26B 21/56; B26B 21/60

(52) U.S. Cl. CPC B26B 21/56; B26B 21/60

(57) ABSTRACT

A razor blade is proposed. The razor blade may include a substrate that has a substrate tip formed at an end portion and includes a first substrate facet and a second substrate facet extending from the substrate tip to both sides. The razor blade may also include a coating that is joined to the substrate and has a coating tip formed at an end portion and includes a first coating facet and a second coating facet extending from the coating tip to both sides and corresponding to the first substrate facet and the second substrate facet, respectively. The substrate may further include a third substrate facet extending from one end of the first substrate facet. A line tangential to the first substrate facet and a line tangential to the third substrate facet may not be parallel to each other.

### CROSS-REFERENCE TO RELATED APPLICATION

This is a continuation application of International Patent Application No. PCT/KR2022/018358 filed Nov. 18, 2022, which claims priority to Korean Patent Application No. 10-2021-0160597 filed on Nov. 19, 2021, the contents of each of which are incorporated by reference herein in their entirety.

### BACKGROUND

### Technical Field

The present disclosure relates to a razor blade. More particularly, the present disclosure relates to a razor blade having an asymmetric shape.

### Description of Related Technology

A shaving experience perceived by a user feels during shaving may vary greatly depending on a shape of a razor blade. In particular, a shape of a substrate of the razor blade significantly affects the cutting force of the razor blade.

### SUMMARY

One aspect is an asymmetric razor blade shape that can improve durability of a razor blade and reduce a cutting force of the razor blade.

Another aspect is a razor blade comprising: a substrate that has a substrate tip formed at an end portion and includes a first substrate facet and a second substrate facet extending from the substrate tip to both sides; and a coating that is joined to the substrate and has a coating tip formed at an end portion and includes a first coating facet and a second coating facet extending from the coating tip to both sides and corresponding to the first substrate facet and the second substrate facet, respectively, wherein the substrate further includes a third substrate facet extending from one end of the first substrate facet, and a line tangential to the first substrate facet and a line tangential to the third substrate facet are not parallel to each other.

According to various non-limiting embodiments, by having asymmetrical cutting edges with different shapes, it is possible to provide a razor blade capable of improving the durability and reducing the cutting force.

### BRIEF DESCRIPTION OF THE DRAWINGS

FIG. 1 is a schematic diagram of a razor blade according to a first embodiment of the present disclosure.

FIG. 2 is a schematic diagram of a substrate in the razor blade according to the first embodiment of the present disclosure.

FIG. 3 is a schematic diagram of an area near a coating tip of the razor blade according to the first embodiment of the present disclosure.

FIG. 4 is a schematic diagram of a razor blade according to a second embodiment of the present disclosure.

FIGS. 5A and 5B are exemplary diagrams illustrating a situation in which a person is shaving using a razor including a razor blade according to an embodiment of the present disclosure.

### DETAILED DESCRIPTION

Generally, as a thickness of the substrate becomes thinner, the cutting force of the razor blade further decreases. In this case, the user may feel a more comfortable shaving experience. However, when the thickness of the substrate becomes thinner than a predetermined value, the durability of the razor blade may deteriorate. That is, in designing a profile of the razor blade, there is a trade-off relationship between comfortable shaving experience and durability of the razor blade.

In this regard, it has been known that an area near a tip of the razor blade has a high correlation with the durability of the razor blade, and the area spaced apart from the tip of the razor blade has a high correlation with the cutting force of the razor blade.

U.S. Pat. No. 10,549,438 (hereinafter referred to as Patent Document 1), which is the conventional razor blade, discloses a profile of a razor blade with two facets that takes this correlation into account.

Specifically, the razor blade of Patent Document 1 includes a pair of first facets extending from the tip of the razor blade and a pair of second facets extending from each first facet. In addition, the first facet and the second facet form a wedge shape, and the pair of first facets is configured to form a wide facet angle.

As a result, the razor blade of Patent Document 1 may have a relatively wide area in the area near the tip and a relatively narrow area in the area spaced apart from the tip. As a result, the razor blade of Patent Document 1 may provide a comfortable shaving experience while having high durability.

Meanwhile, during shaving, the razor blade proceeds along a shaving direction while being slightly laid down with respect to a skin surface. In this case, a cutting edge of the razor blade may be divided into a non-facing edge disposed in the front in a shaving direction and a facing edge disposed in the rear in the shaving direction. Among those, at least a portion of the facing edge is in direct contact with a user's skin during shaving.

The contact between the razor blade and the user's skin may directly affect the shaving experience and the durability of the razor blade. From this perspective, the facing edge that is adjacent to the user's skin may have more effect on the shaving feeling and the durability of the razor blade compared to the non-facing edge.

Therefore, in designing the profile of the razor blade, the non-facing edge and the facing edge need to be designed differently to reflect the characteristics of each edge.

However, the conventional razor blade, including Patent Document 1, generally has cutting edges with symmetrical shapes without differentiation between the non-facing edge and the facing edge. In other words, most of the conventional razor blades do not sufficiently consider the characteristics of the non-facing edge and the facing edge.

Hereinafter, some embodiments of the present disclosure will be described in detail with reference to the accompanying drawings. It is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention.

Terms ‘first’, ‘second’, i), ii), a), b), and the like, will be used in describing components according to embodiments of the present disclosure. These terms are only for distinguishing the components from other components, and the nature, sequence, order, or the like of the components are not limited by the terms. Throughout the present specification, unless explicitly described to the contrary, “including” or “comprising” any components will be understood to imply the inclusion of other elements rather than the exclusion of any other elements.

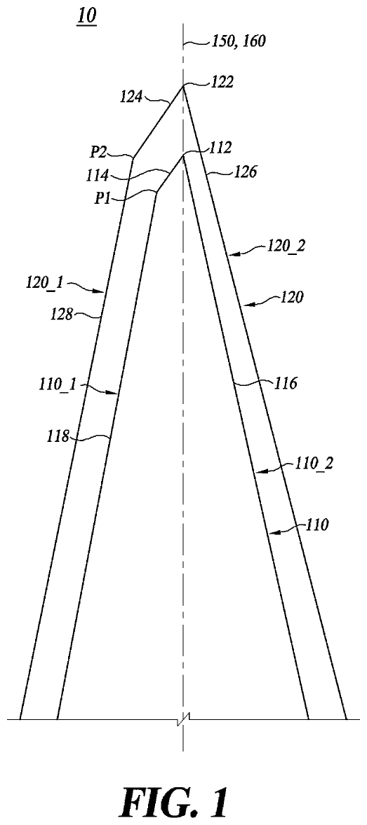

FIG. 1 is a schematic diagram of a razor blade according to a first embodiment of the present disclosure.

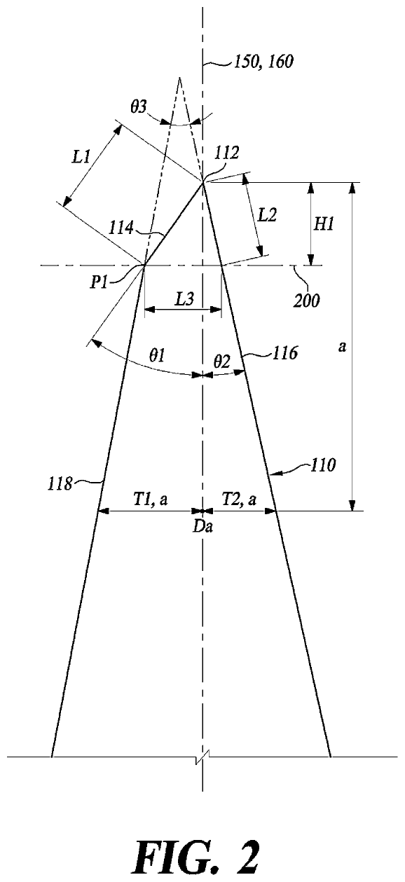

FIG. 2 is a schematic diagram of a substrate in the razor blade according to the first embodiment of the present disclosure.

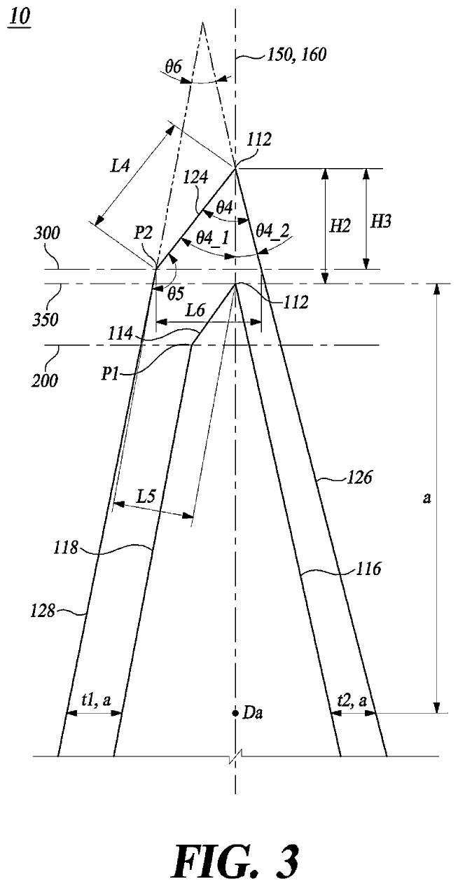

FIG. 3 is a schematic diagram of an area near a coating tip of the razor blade according to the first embodiment of the present disclosure.

Referring to FIGS. 1 to 3, a razor blade 10 according to a first embodiment of the present disclosure may include a substrate 110 and a coating 120 joined to the substrate 110.

The substrate 110 may include a substrate tip 112, a first substrate facet 114, a second substrate facet 116, and a third substrate facet 118.

The substrate tip 112 is formed at an end portion of the substrate 110, and the first substrate facet 114 and the second substrate facet 116 may extend from the substrate tip 112 to both sides. The third substrate facet 118 may extend from one end of the first substrate facet 114.

In this case, a line tangential to the first substrate facet 114 and the line tangential to the third substrate facet 118 may not be parallel to each other. Conversely, the second substrate facet 116 may continue to have a flat profile. Accordingly, the substrate 110 may have an asymmetric shape with respect to a first vertical centerline 150 passing through the substrate tip 112 while dividing the substrate 110 in two. That is, the substrate 110 may have a wedge shape at a point where the first substrate facet 114 and the third substrate facet 118 meet.

Meanwhile, hereinafter, a point where the first substrate facet 114 and the third substrate facet 118 meet is referred to as a first point P1, a surface where the first substrate facet 114 and the third substrate facet 118 are formed is referred to as a first substrate surface 110_1, and a surface where the second substrate facet 116 is formed is referred to as a second substrate surface 110_2.

In addition, the substrate 110 may include at least one of stainless steel, carbon steel, and ceramic. However, the present disclosure is not limited thereto, and the substrate 110 may include other materials.

The coating 120 may include a coating tip 122, a first coating facet 124, a second coating facet 126, and a third coating facet 128.

The coating tip 122 is formed at an end portion of the coating 120, and the first coating facet 124 and the second coating facet 126 may extend from the coating tip 122 to both sides. The third coating facet 128 may extend from one end of the first coating facet 124.

Accordingly, the first coating facet 124, the second coating facet 126, and the third coating facet 128 may correspond to the first substrate facet 114, the second substrate facet 116, and the third substrate facet 118, respectively.

In this case, a line tangential to the first coating facet 124 and a line tangential to the third coating facet 128 may not be parallel to each other. Conversely, the second coating facet 126 may continue to have a flat profile. As a result, the coating 120 may have an asymmetric shape based on a second vertical centerline 160 passing through the coating tip 122 while dividing the coating 120 in two. That is, the coating 120 may have a wedge shape at a point where the first coating facet 124 and the third coating facet 128 meet.

Meanwhile, hereinafter, a point where the first coating facet 124 and the third substrate facet 128 meet is referred to as a second point P2, a surface where the first coating facet 124 and the third coating facet 128 are formed is referred to as a first coating surface 120_1, and a surface where the second coating facet 126 is formed is referred to as a second coating surface 120_2.

During shaving, for example, the first coating surface 120_1 may be a non-facing edge, and the second coating surface 120_2 may be a facing edge. However, it is not necessarily limited thereto, and the first coating surface 120_1 may be the facing edge, and the second coating surface 120_2 may be the non-facing edge. Accordingly, the razor blade 10 according to the first embodiment of the present disclosure may have the non-facing edge and the facing edge that have an asymmetrical shape to each other.

However, the coating 120 does not necessarily have an asymmetric shape, and may also be configured to have a symmetrical shape with respect to the second vertical centerline 160.

The coating 120 may include a hard coating layer to reinforce the durability of the razor blade 10. For example, the hard coating layer of the coating 120 may include at least one of diamond-like carbon (DLC), Cr, Pt, CrB, and CrC. However, the present disclosure is not limited thereto, and the hard coating layer of the coating 120 may include other materials.

The coating 120 may include a soft coating layer to reduce a friction force of the razor blade 10. For example, the soft coating layer of the coating 120 may include polytetrafluoroethylene (PTFE). However, the present disclosure is not limited thereto, and the soft coating layer of the coating 120 may include materials other than PTFE.

The coating 120 may additionally include an overcoat layer disposed between the hard coating layer and the soft coating layer and an adhesive layer disposed between the substrate 110 and the hard coating layer.

Meanwhile, the substrate 110 according to the first embodiment of the present disclosure is configured to have a wedge shape at the point where the first substrate facet 114 and the third substrate facet 118 meet, so it may be relatively easy to join the asymmetrical-shaped coating 120 to the substrate 110.

Conventionally, in order to join the asymmetrical-shaped coating 120 to the symmetrical-shaped substrate 110, coatings of different thicknesses are formed on each symmetrical surface to form an asymmetrical shape, so the coating 120 was bound to be relatively thick. However, even if the coating 120 is joined to the shape of the substrate 110, the razor blade 10 according to the first embodiment of the present disclosure may obtain the asymmetrical-shaped coating 120, so the thickness of the coating 120 may become relatively thinner.

As the thickness of the coating 120 becomes thinner, the cutting force decreases, and the adhesion of the coating 120 increases, thereby improving the durability.

Hereinafter, the shapes of the substrate 110 and coating 120 required for more efficient shaving will be described in detail. In addition, hereinafter, a direction parallel to the first vertical centerline 150 is referred to as a vertical direction, and a direction perpendicular to the first vertical centerline is referred to as a horizontal direction. This also applies to the second vertical centerline 160, which will be described later.

Meanwhile, the numerical range described below is only an example, and the present disclosure is not necessarily limited to the numerical range.

Referring to FIG. 1, the razor blade 10 according to the first embodiment of the present disclosure may have a first vertical centerline 150 and a second vertical centerline 160 that coincide with each other. In this case, the coating tip 122 and the substrate tip 112 may be arranged on the same line.

During shaving, a pressing force from the razor blade 10 is transmitted to the coating tip 122 through the substrate tip 112, and finally, is transmitted to a user's skin through the coating tip 122. When the substrate tip 112 and the coating tip 122 are disposed on the same line, all the pressing force transmitted from the substrate tip 112 to the coating tip 122 may be used to cut body hair without being lost at one moment, so the shaving may be performed with less force.

Additionally, the shapes of the substrate 110 and the coating 120 may generally match each other, so the overall durability of the razor blade 10 may be improved.

Referring to FIG. 2, when a line passing through the first point P1 while being parallel to the horizontal direction is referred to as a first horizontal line 200, a distance H1 measured in the vertical direction from the substrate tip 112 to the first horizontal line 200 may be 0.05 to 0.25 μm, preferably 0.08 to 0.17 μm, and more preferably 0.13 to 0.16 μm.

The distance L1 between the substrate tip 112 and the first point P1 may be 0.05 to 0.25 μm, preferably 0.08 to 0.2 μm, and more preferably 0.14 to 0.18 μm.

A distance L2 from the substrate tip 112 to the point where the first horizontal line 200 meets the second substrate facet 116 may be 0.05 to 0.25 μm, and preferably 0.08 to 0.18 μm, and more preferably 0.14 to 0.16 μm.

A distance L3 measured in the horizontal direction from the first point P1 to the second substrate facet 116 may be 0.05 to 0.3 μm, preferably 0.1 to 0.22 μm, and more preferably 0.12 to 0.2 μm.

Meanwhile, assuming that a point, which is a m away from the substrate tip 112 in the vertical direction, is Da, at point Da, a horizontal distance between the first vertical centerline 150 and the first substrate facet 114 or the first vertical centerline 150 and the third substrate facet 118 is referred to as T1,a and a horizontal distance between the first vertical centerline 150 and the second substrate facet 116 is referred to as T2,a.

At point D0.3, which is 0.3 μm away from the substrate tip 112 in the vertical direction, a horizontal distance T1, 0.3 between the first vertical centerline 150 and the third substrate facet 118 may be 0.131 to 0.243 μm, and a horizontal distance T2, 0.3 between the first vertical centerline 150 and the second substrate facet 116 may be 0.084 to 0.156 μm.

In addition, the ranges of T1,a and T2,a in other major Da values, including the numerical range in D0.3 above, are shown in Table 1 below. Here, min means a minimum value, and max means a maximum value.

TABLE 1

| | T1, a | | T2, a | |
|---|---|---|---|---|
| a | (μm) | | (μm) | |
| (μm) | min | max | min | max |
| 0.1 | 0.084 | 0.156 | 0.037 | 0.069 |
| 0.2 | 0.11 | 0.204 | 0.062 | 0.115 |
| 0.3 | 0.131 | 0.243 | 0.084 | 0.156 |
| 0.4 | 0.154 | 0.286 | 0.104 | 0.193 |
| 0.5 | 0.174 | 0.323 | 0.128 | 0.238 |
| 0.6 | 0.191 | 0.355 | 0.147 | 0.273 |
| 0.7 | 0.208 | 0.386 | 0.167 | 0.31 |
| 0.8 | 0.221 | 0.41 | 0.182 | 0.338 |
| 0.9 | 0.236 | 0.438 | 0.198 | 0.368 |
| 1 | 0.25 | 0.464 | 0.216 | 0.401 |
| 2 | 0.384 | 0.713 | 0.369 | 0.685 |
| 3 | 0.506 | 0.94 | 0.525 | 0.975 |

In addition, an angle θ1 formed by the first vertical centerline 150 and a line tangential to the first substrate facet 114 may be 40° to 55°, preferably 42° to 52°, and more preferably 45° to 50°.

In addition, an angle θ2 formed by the first vertical centerline 150 and a line tangential to the second substrate facet 116 may be 15° to 30°, preferably 17° to 28°, and more preferably 20° to 25°.

An angle θ3 formed at a virtual point where the line tangential to the third substrate facet 118 and the line tangential to the second substrate facet 116 extend and meet may be 25° to 40°, preferably 25° to 36°, and more preferably 28° to 32°.

Meanwhile, tip angles θ1 and θ2 defined in the area near the coating tip 122 of the razor blade 10 has a high correlation with the durability of the razor blade 10. For example, as the tip angles θ1 and θ2 increase, the durability of the razor blade 10 may be improved.

Accordingly, the razor blade 10 according to the first embodiment of the present disclosure may further improve the durability of the razor blade 10 by having the large tip angles θ1 and θ2.

Referring to FIG. 3, a distance H2 between the substrate tip 112 and the coating tip 122 may be 0.1 to 0.4 μm, and preferably 0.15 to 0.35 μm.

When a line passing through a second point P2 while being parallel to the horizontal direction is referred to as a second horizontal line 300, a distance H3 measured in a vertical direction from the coating tip 122 to the second horizontal line 300 may be 0.1 to 0.5 m, preferably 0.12 to 0.35 μm, and more preferably 0.13 to 0.3 μm.

A distance L4 between the coating tip 122 and the second point P2 may be 0.15 to 0.4 μm, and a distance L5 between the substrate tip 112 and the second point P2 may be 0.05 to 0.2 μm.

A distance L6 measured in the horizontal direction from the second point P2 to the second coating facet 126 may be 0.15 to 0.35 μm, and preferably 0.17 to 0.32 μm.

In addition, an angle θ4 formed by the line tangential to the first coating facet 124 and the line tangential to the second coating facet 126 may be 45° to 85°, and preferably 50° to 70°.

In addition, an angle θ4_1 formed by the line tangential to the first coating facet 124 and the line tangential to the second vertical centerline 160 may be 36° to 59°, and preferably 40° to 52°. In addition, an angle θ42 formed by the line tangential to the second coating facet 126 and the line tangential to the second vertical centerline 160 may be 16° to 32°, and preferably 20° to 28°.

An angle θ5 formed by the line tangential to the first coating facet 124 and the line tangential to the third coating facet 128 may be 120° to 165°, and preferably 130° to 1600.

An angle θ6 formed by the line tangential to the third coating facet 128 and the line tangential to the second coating facet 126 may be 25° to 50°, and preferably 30° to 450.

Meanwhile, when a line passing through the substrate tip 112 while being parallel to the horizontal direction is referred to as the substrate tip horizontal line 350, a value obtained by subtracting the distance H3 measured in the vertical direction from the coating tip 122 to the second horizontal line 300 from the distance H2 measured in the vertical direction from the coating tip 122 to the substrate tip horizontal line 350 may be −0.08 to 0.15, and preferably −0.05 to 0.1.

In addition, in Da, a horizontal distance between a first substrate surface 110_1 and a first coating surface 120_1 is referred to as t1,a, and a horizontal distance between a second substrate surface 110_2 and a second coating surface 120_2 is referred to as t2,a.

At a point D0.3, which is 0.3 μm away from the substrate tip horizontal line 350 in the vertical direction, a horizontal distance t2, 0.3 between the second substrate surface 110_2 and the second coating surface 1202, for example, the horizontal distance between the second substrate facet 116 and the second coating facet 126 may be 0.06 to 0.3 μm, preferably 0.08 to 0.25 μm, and more preferably 0.08 to 0.18 μm.

In addition, at D0.3, a horizontal distance t1, 0.3 between the first substrate surface 110_1 and the first coating surface 120_1, for example, a horizontal distance between the third substrate facet 118 and the third coating facet 128 may be 0.04 to 0.18 μm, preferably 0.04 to 0.15 μm, and more preferably 0.04 to 0.13 μm.

Meanwhile, at a point D0.5, which is 0.5 μm away from the substrate tip horizontal line 350 in the vertical direction, a horizontal distance t2, 0.5 between the second substrate surface 110_2 and the second coating surface 1202, for example, the horizontal distance between the second substrate facet 116 and the second coating facet 126 may be 0.05 to 0.25 μm, preferably 0.08 to 0.25 μm, and more preferably 0.08 to 0.17 μm.

In addition, at D0.5, a horizontal distance t1, 0.5 between the first substrate surface 110_1 and the first coating surface 120_1, for example, a horizontal distance between the third substrate facet 118 and the third coating facet 128 may be 0.04 to 0.16 μm, preferably 0.04 to 0.15 μm, and more preferably 0.04 to 0.12 μm.

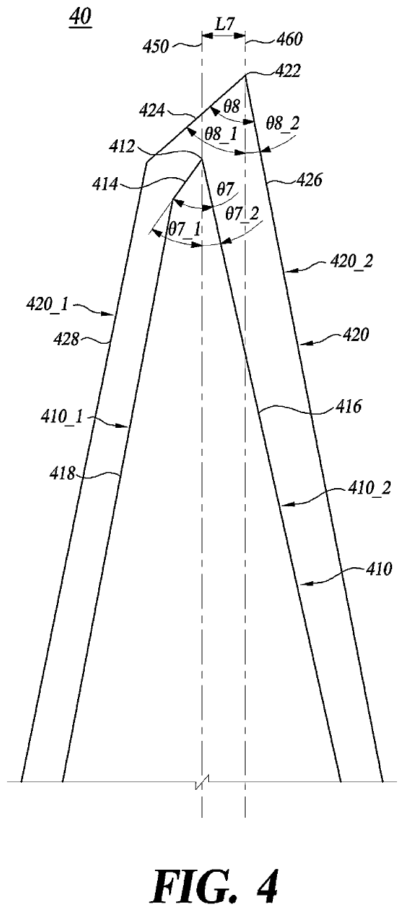

FIG. 4 is a schematic diagram of a razor blade according to a second embodiment of the present disclosure.

Referring to FIG. 4, compared to the razor blade 10 according to the second embodiment of the present disclosure, the razor blade 40 according to the second embodiment of the present disclosure has a difference in that a first vertical centerline 450 and a second vertical centerline are spaced apart from each other. For example, the second vertical centerline 460 may be biased toward the second substrate facet 416.

In this case, a horizontal distance L7 between the first vertical centerline 450 and the second vertical centerline 460 may be 0.01 to 0.17 μm, preferably 0.01 to 0.13 m, and more preferably 0.01 and 0.1 μm.

In this case, compared to the razor blade 10 according to the first embodiment, the thickness of the second coating facet 426 may be thicker and the angle at which the shaving is performed may increase, thereby minimizing skin irritation.

In addition, a ratio of an angle θ7_1 formed by the first vertical centerline 450 and a line tangential to the first substrate facet 414 and an angle θ7_2 formed by the first vertical centerline 450 and a line tangential to a second substrate facet 416 may be approximately 69.369 to 30.631 based on 100.

A ratio of an angle θ8_1 formed by the second vertical centerline 460 and a line tangential to a first coating facet 424 and an angle θ82 formed by the second vertical centerline 460 and a line tangential to a second coating facet 426 may be approximately 65.517 to 34.483 based on 100.

In addition, at a major Da, Table 2 below shows the ratio of the horizontal distance from the first vertical centerline 450 to the first coating surface 420_1 and the second coating surface 420_2 and the ratio of the horizontal distance from the second vertical centerline 460 to the first coating surface 420_1 and the second coating surface 420_2 is Table based on 100.

TABLE 2

| | Based on first | | Based on second | |
|---|---|---|---|---|
| | vertical centerline | | vertical centerline | |
| | First | Second | First | Second |
| a | coating | coating | coating | coating |
| (μm) | surface | surface | surface | surface |
| 0.1 | 75.348 | 24.652 | 71.291 | 28.709 |
| 0.2 | 68.652 | 31.348 | 63.926 | 36.074 |
| 0.3 | 65.057 | 34.943 | 61.007 | 38.993 |
| 0.4 | 62.891 | 37.109 | 60.015 | 39.985 |
| 0.5 | 61.65 | 38.35 | 58.748 | 41.252 |

Meanwhile, the razor blade 40 according to the second embodiment of the present disclosure may be the same as the description of the razor blade 10 according to the first embodiment to the extent that it does not conflict with each other, except for the matters described above, and therefore, detailed description thereof will be omitted.

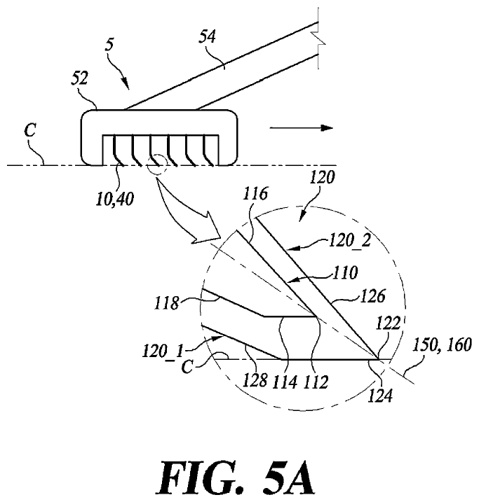

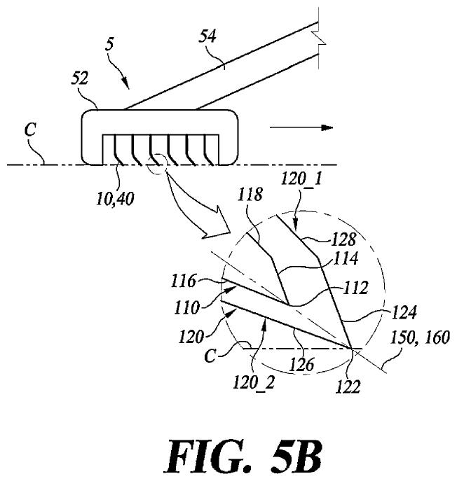

FIGS. 5A and 5B are exemplary diagrams illustrating a situation in which a person is shaving using a razor including a razor blade according to an embodiment of the present disclosure.

Specifically, FIG. 5A illustrates the razor blades 10 and 40 when the first coating surface 120_1 is the facing edge, and FIG. 5B illustrates the razor blades 10 and 40 when the second coating surface 120_2 is the facing edges 10 and 40.

Meanwhile, in FIGS. 5A and 5B, the razor blade 10 according to the first embodiment of the present disclosure is illustrated in an enlarged form, but the following may also be described for the razor blade 40 according to the second embodiment of the present disclosure.

Referring to FIGS. 5A and 5B, a razor 5 may include a razor cartridge 52 and a razor handle 54 extending from the razor cartridge 52.

The razor cartridge 52 may be connected to the razor handle 54 or may be formed integrally with the razor handle 54. In addition, the razor cartridge 52 may accommodate at least one razor blade 10 or 40 therein.

Referring to FIG. 5A, at least a portion of the first coating surface 120_1, which is the facing edge, may be adjacent to a user's skin C during the shaving.

In addition, the first coating surface 120_1 may have a wedge shape between the first coating facet 124 and the third coating facet 128, and this wedge shape forms a protruding area on the first coating surface 120_1.

Accordingly, when the razor blades 10 and 40 come close to the skin C enough to contact the skin C, the first coating surface 120_1 may contact the skin C in more areas.

In this case, the tendency of the coating tip 122 to contact the skin C may be reduced, and thus, the razor blades 10 and 40 may provide a comfortable shaving feeling without blemishes, cuts, or scratches on the skin.

Referring to FIG. 5B, at least a portion of the second coating surface 120_2, which is the facing edge, may be adjacent to the user's skin C during the shaving.

In addition, the second coating surface 120_2 and the second coating facet 126 may have a flat profile. Accordingly, when the razor blades 10 and 40 come close enough to the skin C to contact the skin C, the second coating surface 120_2 may contact the skin C in a smaller area.

In this case, the coating tip 122 may access a lower area of hair adjacent to the skin C, and thus, the hair cut by the razor blades 10 and 40 may have a shorter length. As a result, the razor blades 10 and 40 may provide a cleaner shave.

The spirit of the present embodiment is illustratively described hereinabove. It will be appreciated by those skilled in the art to which the present embodiment pertains that various modifications and alterations may be made without departing from the essential characteristics of the present embodiment. Accordingly, the present embodiments are not to limit the spirit of the present embodiment, but are to describe the spirit of the present embodiment. The technical idea of the present embodiment is not limited to these embodiments. The scope of the present embodiment should be interpreted by the following claims, and it should be interpreted that all the spirits equivalent to the following claims fall within the scope of the present embodiment.

What is claimed is:

1. A razor blade comprising:
a substrate comprising:
a substrate tip formed at an end portion, and
a first substrate facet and a second substrate facet extending from the substrate tip to both sides; and
a coating joined to the substrate and comprising a coating tip formed at an end portion, the coating comprising:
a first coating facet and a second coating facet extending from the coating tip to both sides and corresponding to the first substrate facet and the second substrate facet, respectively,
wherein the substrate further includes a third substrate facet extending from one end of the first substrate facet, and
wherein a line tangential to the first substrate facet and a line tangential to the third substrate facet are not parallel to each other.

2. The razor blade of claim 1, wherein a first vertical centerline passing through the substrate tip while dividing the substrate in two and a second vertical centerline passing through the coating tip while dividing the coating in two coincide with or are spaced apart from each other.

3. The razor blade of claim 2, wherein the first vertical centerline and the second vertical centerline are spaced apart from each other,
wherein a direction perpendicular to the first vertical centerline is defined as a horizontal direction, and wherein a horizontal distance between the first vertical centerline and the second vertical centerline is 0.01 μm to 0.17 m.

4. The razor blade of claim 1, wherein a direction parallel to a first vertical centerline passing through the substrate tip while dividing the substrate in two is defined as a vertical direction and a direction perpendicular to the first vertical centerline is defined as a horizontal direction, and wherein a distance measured in the vertical direction from the substrate tip to a first horizontal line passing through a point where the first substrate facet and the third substrate facet meet while being parallel with the horizontal direction is 0.05 μm to 0.25 μm.

5. The razor blade of claim 1, wherein a distance between a point where the first substrate facet and the third substrate facet meet and the substrate tip is 0.05 μm to 0.25 μm.

6. The razor blade of claim 1, wherein a direction perpendicular to a first vertical centerline passing through the substrate tip while dividing the substrate in two is defined as a horizontal direction, and wherein a distance from the substrate tip to a point where a first horizontal line passing through a point where the first substrate facet and the third substrate facet meet, parallel to the horizontal direction, meets the second substrate facet is 0.05 μm to 0.25 μm.

7. The razor blade of claim 1, wherein a direction perpendicular to the first vertical centerline passing through the substrate tip while dividing the substrate in two is defined as a horizontal direction, and wherein a distance measured in the horizontal direction from a point where the first substrate facet and the third substrate facet meet to the second substrate facet is 0.05 μm to 0.3 μm.

8. The razor blade of claim 1, wherein a direction parallel to a first vertical centerline passing through the substrate tip while dividing the substrate in two is defined as a vertical direction and a direction perpendicular to the first vertical centerline is defined as a horizontal direction, and wherein a horizontal distance between the first vertical centerline and the third substrate facet at a point, which is 0.3 μm away from the substrate tip in the vertical direction, is 0.131 μm to 0.243 μm.

9. The razor blade of claim 1, wherein a direction parallel to a first vertical centerline passing through the substrate tip while dividing the substrate in two is defined as a vertical direction and a direction perpendicular to the first vertical centerline is defined as a horizontal direction, and wherein a horizontal distance between the first vertical centerline and the second substrate facet at a point, which is 0.3 μm away from the substrate tip in the vertical direction, is 0.084 μm to 0.156 μm.

10. The razor blade of claim 1, wherein a direction parallel to a first vertical centerline passing through the substrate tip while dividing the substrate in two is defined as a vertical direction and a direction perpendicular to the first vertical centerline is defined as a horizontal direction, and wherein a horizontal distance between the second substrate facet and the second coating facet is 0.06 μm to 0.3 μm at a point, which is 0.3 μm away in the vertical direction from a substrate tip horizontal line passing through the substrate tip while being parallel to the horizontal direction.

11. The razor blade of claim 1, wherein a direction parallel to a first vertical centerline passing through the substrate tip while dividing the substrate in two is defined as a vertical direction and a direction perpendicular to the first vertical centerline is defined as a horizontal direction, and wherein a horizontal distance between the second substrate facet and the second coating facet is 0.05 μm to 0.22 μm at a point, which is 0.5 μm away in the vertical direction from a substrate tip horizontal line passing through the substrate tip while being parallel to the horizontal direction.

12. The razor blade of claim 1, wherein an angle formed by a first vertical centerline passing through the substrate tip while dividing the substrate in two and a line tangential to the first substrate facet is 40° to 55°.

13. The razor blade of claim 1, wherein a distance between the substrate tip and the coating tip is 0.1 μm to 0.4 μm.

14. The razor blade of claim 1, wherein the coating further includes a third coating facet extending from one end of the first coating facet and corresponding to the third substrate facet, and wherein a line tangential to the first coating facet and a line tangential to the third coating facet are not parallel to each other.

15. The razor blade of claim 14, wherein a direction parallel to a second vertical centerline passing through the substrate tip while dividing the substrate in two is defined as a vertical direction and a direction perpendicular to the second vertical centerline is defined as a horizontal direction, and wherein a distance measured in the vertical direction from the coating tip to a second horizontal line passing through a point where the first coating facet and the third coating facet meet while being parallel with the horizontal direction is 0.1 μm to 0.5 μm.

16. The razor blade of claim 14, wherein a distance between a point where the first coating facet and the third coating facet meet and the coating tip is 0.15 μm to 0.4 μm.

17. The razor blade of claim 14, wherein a direction perpendicular to a second vertical centerline passing through the coating tip while dividing the coating in two is defined as a horizontal direction, and wherein a distance measured in the horizontal direction from a point where the first coating facet and the third coating facet meet to the second coating facet is 0.15 μm to 0.35 μm.

18. The razor blade of claim 14, wherein a direction parallel to a second vertical centerline passing through the coating tip while dividing the coating in two is defined as a vertical direction and a direction perpendicular to the second vertical centerline is defined as a horizontal direction, and wherein a value obtained by subtracting a distance value measured in the vertical direction from the coating tip to a substrate tip horizontal line passing through the substrate tip, parallel to the horizontal direction, from a distance value measured in the vertical direction from the coating tip to a second horizontal line passing through a point where the first coating facet and the third coating facet meet, parallel to the horizontal direction, is −0.08 to 0.15.

19. The razor blade of claim 14, wherein a direction parallel to a first vertical centerline passing through the substrate tip while dividing the substrate in two is defined as a vertical direction and a direction perpendicular to the first vertical centerline is defined as a horizontal direction, and wherein a horizontal distance between the third substrate facet and the third coating facet is 0.04 μm to 0.18 μm at a point which is 0.3 μm away in the vertical direction from a substrate tip horizontal line passing through the substrate tip while being parallel to the horizontal direction.

20. The razor blade of claim 14, wherein a direction parallel to a first vertical centerline passing through the substrate tip while dividing the substrate in two is defined as a vertical direction and a direction perpendicular to the first vertical centerline is defined as a horizontal direction, and wherein the horizontal distance between the third substrate facet and the third coating facet is 0.04 μm to 0.16 μm at a point which is 0.5 μm away in the vertical direction from a substrate tip horizontal line passing through the substrate tip while being parallel to the horizontal direction.
